(19) United States
(12) Patent Application Publication
(10) Pub. No.: US 2003/0028751 A1
(43) Pub. Date: Feb. 6, 2003

(54) Modular accelerator framework

(76) Inventors: Robert G. McDonald, Austin, TX (US); Barry D. Williamson, Cedar Park, TX (US); Micah R. McDaniel, Austin, TX (US)

Correspondence Address: Lawrence J. Merkel, Conley, Rose, & Tayon, P.C., P.O. Box 398, Austin, TX, 78767, US

(21) Appl. No.: 09/922,516

(22) Filed: Aug. 3, 2001

(51) Int. Cl. G06F 15/00

(52) U.S. Cl. 712/34

(57) ABSTRACT

An acceleration engine may include a set of accelerators and a set of resources coupled to the accelerators. The resources may interface the accelerators to an interconnect, and may provide a programming interface to the accelerators. Since the resources handle interfacing the accelerators to a given interconnect, the accelerators may be insulated from the details of a given system. If more than one accelerator is included in the acceleration engine, some of the resources may be shared by the accelerators. For example, if the resources include a memory for storing data accessed by an accelerator, the memory may be shared between by the accelerators. A methodology for creating an acceleration engine is also described.

### BACKGROUND OF THE INVENTION

1. Field of the Invention

This invention is related to the field of computing systems and, more particularly, to accelerators which may be employed within computing systems.

2. Description of the Related Art

Computing systems generally include one or more central processing units (CPUs) and other hardware elements. Generally, the CPUs execute software to control the overall operation of the computing system and to provide functionality not included in the hardware within the computing system.

In some cases, certain sections of the software can be identified which are frequently executed and consume relatively large amounts of CPU execution time when executed. Such sections may be analyzed to determine if some or all of the functionality represented by the sections can be implemented in hardware accelerators. Generally, each accelerator is custom-designed for a particular computing system.

### SUMMARY OF THE INVENTION

A modular accelerator framework is provided for coupling a set of accelerators and a set of resources. The resources may interface the accelerators to an interconnect, and may provide a programming interface to the accelerators. Since the resources handle interfacing the accelerators to a given interconnect, the accelerators may be insulated from the details of a given system. If more than one accelerator is included in the modular acceleration framework, some of the resources may be shared by the accelerators. For example, if the resources include a memory for storing data accessed by an accelerator, the memory may be shared between by the accelerators.

A methodology for creating an acceleration engine using a modular accelerator framework is also described. The methodology may include selecting, from a library of interface circuit representations, a representation of an interface circuit for interfacing the acceleration engine to an interconnect in a targeted system. Additionally, the methodology may include selecting one or more representations of accelerators from a library of representations of accelerators based on the desired acceleration in the targeted system. A data structure representing the acceleration engine may be formed from the selected interface circuit, the selected accelerator, and other shared resources.

Broadly speaking, an apparatus is contemplated comprising two or more accelerators and one or more resources coupled to the accelerators. Each of the accelerators include circuitry configured to perform a task for an application program. The resources are shared by the accelerators and are configured to interface the accelerators to an interconnect. The resources are further configured to provide a programming interface for communication with the accelerators. A carrier medium is further contemplated carrying a data structure representing the apparatus.

A method is contemplated. An interface circuit is selected from a library of interface circuits dependent on a system into which an accelerator engine comprising the interface circuit is to be included. One or more accelerators are selected from a library of accelerators dependent on which application tasks are to be accelerated. A data structure representing the accelerator engine is formed by coupling a representation of the bus interface circuit, a representation of one or more shared resources, and a representation of the accelerators.

### BRIEF DESCRIPTION OF THE DRAWINGS

The following detailed description makes reference to the accompanying drawings, which are now briefly described.

FIG. 1 is a block diagram of one embodiment of a system.

FIG. 2 is a block diagram illustrating an application program with and without acceleration.

FIG. 3 is a block diagram of one embodiment of an acceleration engine shown in FIG. 1.

FIG. 4 is a block diagram illustrating one embodiment of an input memory shown in FIG. 3.

FIG. 5 is a block diagram illustrating one embodiment of an output memory shown in FIG. 3.

FIG. 6 is a block diagram illustrating one embodiment of a global control circuit shown in FIG. 3.

FIG. 7 is a block diagram illustrating one embodiment of service ports which may be used as a programming interface.

FIG. 8 is a block diagram of one embodiment of a bus interface circuit library and an accelerator library.

FIG. 9 is a flowchart illustrating one embodiment of a methodology for assembling an acceleration engine.

FIG. 10 is a block diagram of one embodiment of a carrier medium.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

System Overview

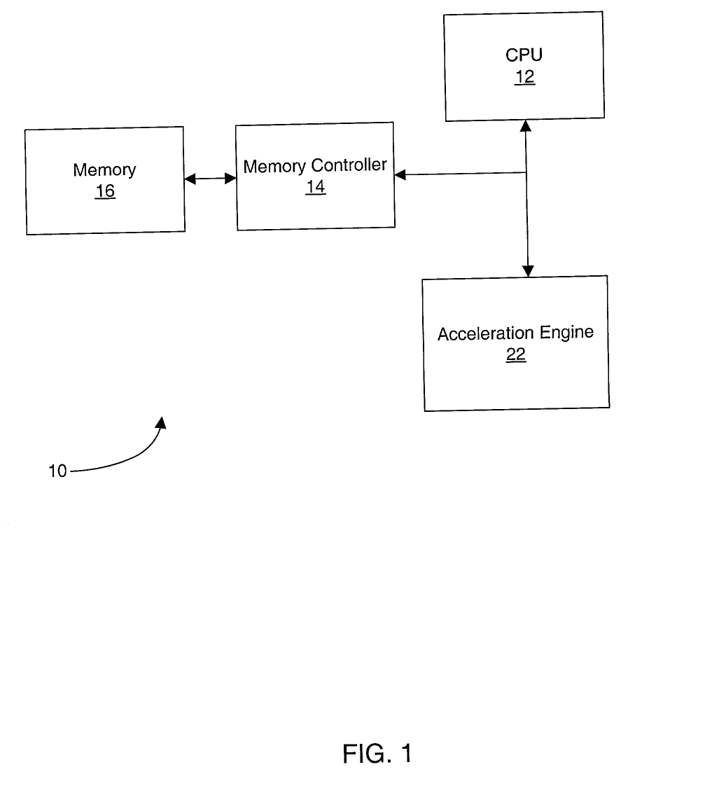

Turning now to FIG. 1, a block diagram of one embodiment of a system 10 is shown. Other embodiments are possible and contemplated. The illustrated system 10 includes a central processing unit (CPU) 12, a memory controller 14, a memory 16, and an acceleration engine 22. The CPU 12 is coupled to the memory controller 14 and the acceleration engine 22. The memory controller 14 is further coupled to the memory 16. In one embodiment, the CPU 12, the memory controller 14, and the acceleration engine 22 may be integrated onto a single chip or into a package (although other embodiments may provide these components separately or may integrate any two of the components and/or other components, as desired).

Generally, the CPU 12 is capable of executing instructions defined in a first instruction set (which may be referred to below as the native instruction set of the system 10). The native instruction set may be any instruction set, e.g. the ARM instruction set, the PowerPC instruction set, the x86 instruction set, the Alpha instruction set, the MIPS instruction set, the SPARC instruction set, etc.

Generally, the CPU 12 executes software coded in native code sequences and controls other portions of the system in response to the software. Generally, the software may be divided into at least two portions: the operating system software and application programs. Generally, the operating system software provides low level control of much of the hardware of the system, and may provide various services which may be used by a wide variety of application programs. The application programs may make calls to the services to have the services executed on behalf of the application program. Generally, application programs are the portion of the software which provides the desired functionality for the user of the system 10. The application programs run “on top” of the operating system software, using the operating system services and low level control functions.

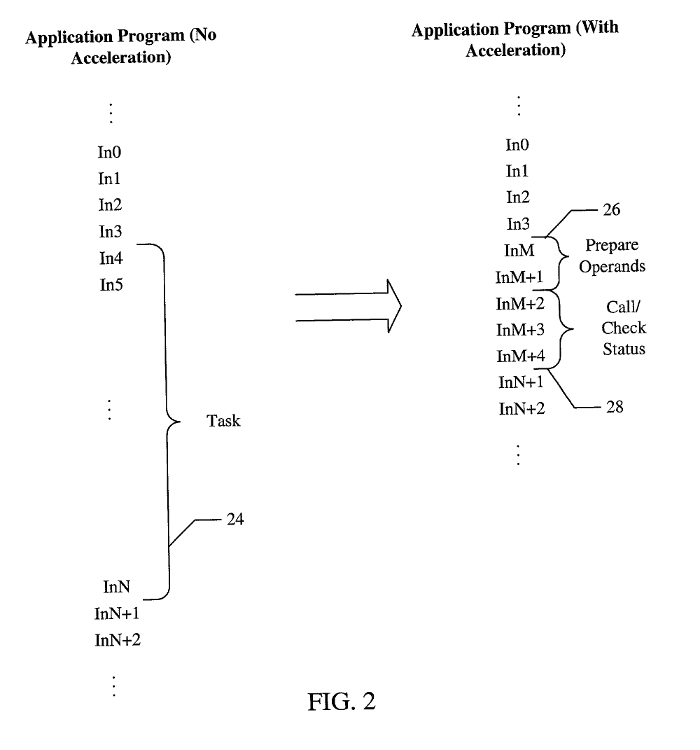

The acceleration engine 22 comprises one or more accelerators for use by the application programs executing on the CPU 12. Each accelerator includes circuitry to perform one or more tasks which would otherwise be performed by native instructions executed by the CPU 12 in the application program. The accelerator operates in parallel with the application program, which may improve performance of the functionality provided by the application program. In many cases, the accelerator may also perform the task in less overall time than the corresponding set of instructions executing on the CPU 12, further improving performance. Thus, as illustrated in FIG. 2, the instructions which would have been used to perform the task may be replaced with instructions for interfacing to the accelerator. The number of instructions for interfacing to the accelerator may be fewer than the number of instructions for performing the task (particularly if the number of instructions is counted dynamically, during execution, rather than the static number of instructions which doesn't reflect the number of times a loop is iterated, for example).

The acceleration engine 22 may have a modular framework, allowing implementations of the acceleration engine 22 to be varied from system implementation to system implementation with minimal design work. Various types of accelerators may be designed without regard to system interface issues. One or more shared resources may be included in the acceleration engine 22 for interfacing the accelerators to the system, and for providing a programming interface for communication between the application program and the accelerators. Since the resources are shared, they are not duplicated in the various accelerators which may be selected for inclusion in the acceleration engine 22. Thus, various implementations of the acceleration engine 22 may be fabricated by including different combinations of accelerators. Furthermore, if the acceleration engine 22 with the same set of accelerators is to be used in a different system implementation (e.g. different interconnect, different CPU architecture, etc.), one or more of the shared resources may be changed without changing the accelerators. Additional details of one embodiment of the modular framework are provided below.

The memory controller 14 receives memory read and write operations from the CPU 12 and the acceleration engine 22 and performs these read and write operations to the memory 16. The memory 16 may comprise any suitable type of memory, including SRAM, DRAM, SDRAM, RDRAM, or any other type of memory.

It is noted that, in one embodiment, the interconnect between the acceleration engine 22, the CPU 12, and the memory controller 14 may be a bus (e.g. the Advanced RISC Machines (ARM) Advanced Microcontroller Bus Architecture (AMBA) bus, including the Advanced High-Performance (AHB) and/or Advanced System Bus (ASB)). Alternatively, any other suitable bus may be used, e.g. the Peripheral Component Interconnect (PCI), the Universal Serial Bus (USB), IEEE 1394 bus, the Industry Standard Architecture (ISA) or Enhanced ISA (EISA) bus, the Personal Computer Memory Card International Association (PCMCIA) bus, the Handspring Interconnect specified by Handspring, Inc. (Mountain View, Calif.), etc. may be used. Still further, the acceleration engine 22 may be connected to the memory controller 14 and the CPU 12 through a bus bridge (e.g. if the acceleration engine 22 is coupled to the PCI bus, a PCI bridge may be used to couple the PCI bus to the CPU 12 and the memory controller 14). In other alternatives, the acceleration engine 22 may be directly connected to the CPU 12 or the memory controller 14, or may be integrated into the CPU 12, the memory controller 14, or a bus bridge. Furthermore, while a bus is used in the present embodiment, any interconnect may be used. Generally, an interconnect is a communication medium for various devices coupled to the interconnect.

Application Acceleration

As mentioned above, the acceleration engine 22 may include one or more accelerators for accelerating application tasks. FIG. 2 is an example illustrating a portion of an application program written without the availability of an accelerator for performing an application task and that application program written with the availability of the accelerator for performing the task. As shown in FIG. 2, the application program on the left side includes the instructions which implement an application task (enclosed by the brace 24). For example, instructions In0-In3 may be related to some other application task, instructions In4-InN may be related to the application task which may be implemented in an accelerator, and the instructions InN+1-InN+2 may be related to some other application task. Thus, to perform the task represented by the brace 24, the CPU 12 executes the instructions enclosed by the brace 24. The total amount of CPU time used to execute the application program includes time spent by the CPU 12 executing the instructions to perform the task.

On the other hand, if the task is implemented in an accelerator, the application program may be written to make use of the accelerator. A portion of such an application program is shown on the right side in FIG. 2. The instructions In0-In3 and InN+1-InN+2 remain in the application program. However, instead of the instructions In4-InN as illustrated in the application program on the left side of FIG. 2, the instructions InM-InM+4 are illustrated. As illustrated by the braces 26 and 28, respectively, some of the instructions may be used to prepare operands for a call to the accelerator (e.g. instructions InM-InM+1 in FIG. 2) and other instructions may be used to perform the call and check the status of the accelerator and/or read results produced by the accelerator (e.g. instructions InM+2-InM+4 in FIG. 2). The number of instructions used to prepare operands and make the call/check status is merely exemplary in FIG. 2 and may be more or less than the number of instructions shown, in general. Also, instructions to check the status of the accelerator may be separated from the call instructions by other instructions (e.g. InN+1-InN+2) which are not dependent on the result of the accelerator.

Accordingly, for the application program written to use the accelerator, the total amount of CPU time used to execute the application program may include the time to execute the instructions to prepare operands, execute the call, and check the status/read results. However, the total amount of CPU time may not include the instructions to actually perform the task now being performed by the accelerator. If the amount of CPU time used to execute the instructions to prepare the operands, execute the call, and check the status of the accelerator/read results of the accelerator is less than the time to perform the task, CPU time may be saved. The CPU time may be used to perform other tasks, etc. Overall performance may be increased, in some cases, by freeing CPU time for other tasks. Furthermore, if the accelerator is capable of performing the task more rapidly than the execution of corresponding instructions on the CPU, the overall performance of the application program may be increased (e.g. reduced total execution time).

Generally, accelerators may be designed to perform any application task. An application task is the function provided by a sequence of instructions included in the application (in the absence of an accelerator to perform the task). The accelerator includes circuitry which, when provided with operands or commands corresponding to the task, performs the task.

A first example accelerator may be a code translator. The code translator may translate code sequences coded using a second instruction set, different from the native instruction set, to a code sequence coded using the native instruction set. Code sequences coded using the second instruction set are referred to as “non-native” code sequences, and code sequences coded using the first instruction set of the CPU 12 are referred to as “native” code sequences. The code translator may be used instead of software which performs the translation (also referred to as just-in-time compilation, if the non-native code is Java bytecode). Alternatively, the code translator may be used instead of software which interprets the non-native code sequence.

The programming interface to the code translator may include a command to translate (which may include the source address of the non-native code sequence to be translated). The code translator may be assigned a block of memory for storing translated code sequences, and may store the translated native code sequence in the block of memory. The programming interface may include a command to check the status of the translation and, if the translation is successful, the code translator may return the address of the translated native code sequence. The CPU 12 may execute the translated code sequence. Furthermore, the code translator may operate the block of memory as a cache, and the programming interface may include commands to check the cache for a translation prior to requesting a translation.

As used herein, the term “translation” refers to generating one or more instructions in a second instruction set which provide the same result, when executed, as executing a first one or more instructions in a first instruction set. For example, the one or more instructions may perform the same operation or operations on the operands of the first one or more instructions to generate the same result the first one or more instructions would have generated. Additionally, the one or more instructions may have the same effect on other architected state as the first one or more instructions would have had.

Another example accelerator may be a decompressor. The decompressor may decompress data from a source memory location to a target memory location. Any decompression algorithm may be employed. The decompressor may be used instead of a code sequence which performs the decompression algorithm.

The programming interface to the decompressor may include a command to supply the target address and a command to decompress (with the source address as an operand). The programming interface may further include a status command to determine if the decompression is complete and/or successful.

Yet another example accelerator may be a parser. The parser may be configured to search through a data structure (e.g. a file, data tagged according to a markup language, etc.) to locate certain keywords, delimiters, etc. The parser may be used instead of code sequences to perform the parsing.

The programming interface to the parser may include a command to begin parsing (which may include the source address of the data structure as an operand). The programming interface may further include commands to select the next item in the data structure and supply the type of item and/or the item itself.

The above accelerator examples are some of the accelerators that may be defined. Any accelerator may be provided, as desired.

It is noted that the a programming interface to the accelerator is used by the application program in this example. Thus, the application program may communicate directly with the accelerator using the programming interface. Other embodiments may allow for operating system involvement in the programming interface, if desired. In one particular example, the programming may be a set of addresses which are memory-mapped to the accelerator (and assigned to the application program). Different commands may be passed to the accelerator using loads/stores to the addresses, and the data passed in the load/store operation may be the operands/results of the commands. However, other embodiments may include any programming interface (e.g. command registers, passing messages through memory locations, etc.). As used herein, a programming interface is a documented communication mechanism which may be used by a program to communicate with a device (e.g. an accelerator).

It is noted that, while the example application program illustrated on the right in FIG. 2 eliminates the instructions to perform the accelerated task (e.g. the instructions enclosed by brace 24), other embodiments may retain those instructions. For example, some embodiments of the accelerators may accelerate the common occurrences of a task but not the exceptional conditions which may occasionally occur. In such cases, the application program may perform the task after detecting that an exception condition has occurred (e.g. a status check of the accelerator reports the exception or an interrupt from the accelerator).

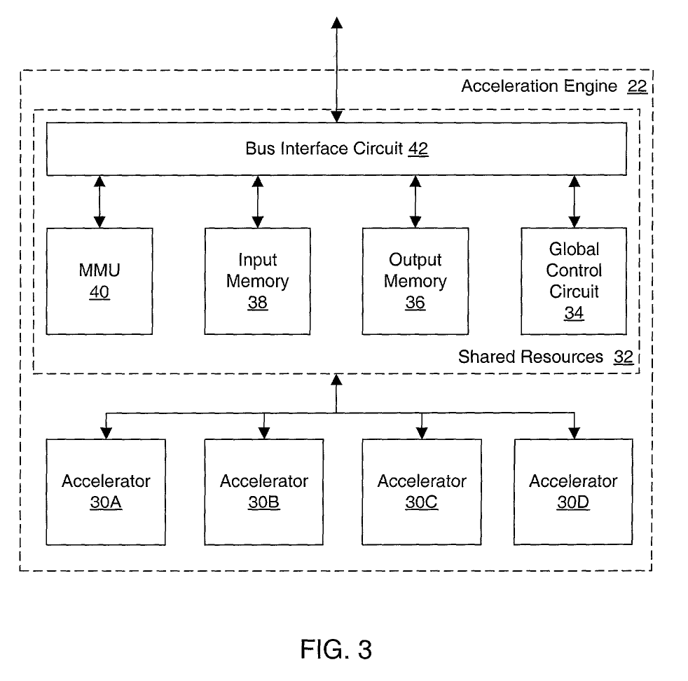

Turning next to FIG. 3, a block diagram of one embodiment of the acceleration engine 22 is shown. Other embodiments are possible and contemplated. In the embodiment shown, the acceleration engine 22 includes a plurality of accelerators 30A-30D coupled to a set of shared resources 32. In the illustrated embodiment, the shared resources 32 include one or more of a global control circuit 34, an output memory 36, an input memory 38, a memory management unit (MMU) 40, and a bus interface circuit 42. The global control circuit 34, the output memory 36, the input memory 38, and MMU 40 are coupled to the bus interface circuit 42, which is capable of coupling to a bus (e.g. the bus between the CPU 12, the memory controller 14, and the acceleration engine 22 in the embodiment of FIG. 1).

The acceleration engine 22 may provide a modular framework to permit various accelerator combinations to be designed into the acceleration engine 22. The shared resources 32 are shared by the accelerators 30A-30D. In other words, each of the accelerators 30A-30D may make use of the shared resources 32 when activated by an application program. Thus, various accelerators 30A-30D may be designed for various application tasks and with a common interface to the shared resources 32.

The shared resources may handle integration of the acceleration engine 22 into a desired system, and thus the accelerators 30A-30D may be generally system-independent. Specifically, in one embodiment, the shared resources 32 may include circuitry to interface the accelerators to a bus used in the targeted system and may provide the programming interface for the application program. The bus may vary from system to system. Furthermore, details of the programming interface may vary from system to system. For example, in embodiments in which load/store operations to memory-mapped addresses are used as the programming interface, different CPU instruction sets may differ in the details of performing load/store operations. The size (in bits) of the address provided may differ; the size of the data (in bytes) may differ; the arrangement of the bytes within the data provided may differ; etc. The shared resources may insulate the accelerators 30A-30D from such differences.

Additionally, the shared resources 32 may provide resources that many types of accelerators 30A-30D might include (such as an input memory for storing data read from memory by an accelerator or an output memory for storing data written by the accelerator to memory). The use of shared resources may be more efficient in some cases (e.g. in terms of area occupied by the acceleration engine 22) than having separate resources in each accelerator 30A-30D.

The bus interface circuit 42 includes the circuitry for interfacing to the bus to which the acceleration engine 22 is to be coupled. The circuitry drives/receives signals on the bus in accordance with the bus protocol, and communicates with other shared components to provide transactions received on the bus and to receive transactions for driving on the bus.

The global control circuit 34 may include one or more configuration registers controlling the general operation of the acceleration engine 22, the operation of the accelerators 30A-30D, interrupt status, etc. The global control circuit 34 may provide the programming interface functionality of the acceleration engine 22. More specifically, the global control circuit 34 may receive transactions from the bus interface circuit 42 and may interpret those transactions which are part of the programming interface of the acceleration engine 22, decoding the transactions into system-independent command encodings which are routed to the accelerators 30A-30D.

The input memory 38 is a memory for storing data read by the accelerators 30A-30D. At any given time, the data stored in the input memory 38 may be data read by one or more of the accelerators 30A-30D. The input memory 38 may generally include multiple entries for storing data. In one implementation, the entries may also store the address of the data, and the addresses in the entries may be compared to read requests from the accelerators 30A-30D. If the address in an entry matches the address of a read request, the input memory 38 may provide the data to the requesting accelerator 30A-30D. If the address does not match an entry, the address is passed to the bus interface circuit 42. The bus interface circuit 42 may perform a transaction on the bus to read the data from memory, and may supply the data to the input memory 38 for storage. In various embodiments, the data may also be supplied to the requesting accelerator 30A-30D via a bypass path, or the data may be provided via a repeat request by the requesting accelerator 30A-30D to the input memory 38.

The output memory 36 is a memory for storing data written by the accelerators 30A-30D. At any given time, the data stored in the output memory 36 may be data written by one or more of the accelerators 30A-30D. The output memory 36 may generally include multiple entries, each for storing addresses and corresponding data. The output memory 36 may hold the addresses and data until corresponding write transactions are performed on the bus by the bus interface circuit 42.

Each of the input memory 38 and the output memory 36 may be of any construction. For example, the input memory 38 and the output memory 36 may each comprise a buffer, wherein the number of entries in each buffer may be selected in a given implementation of the acceleration engine 22 based on, e.g., the characteristics of the bus, the amount of data expected to be processed by the accelerators, the number of accelerators, etc. The input memory 38 may be a read-only cache, or may be a general data cache, of any configuration (e.g. direct-mapped, set associative, fully associative, etc.). In yet another alternative, a single memory may integrate the features of the input memory 38 and the output memory 36. The input memory 38 and/or the output memory 36 may be maintained coherently with respect to CPU 12 transactions, or may be non-coherent, as desired.

The MMU 40 may be included to translate virtual addresses to physical addresses. As mentioned above, the accelerators 30A-30D are activated by application programs, which may often be operating with virtual addressing. Thus, if the application program passes an address as an operand of a command, the address may be virtual. If the address is used in a read or write by the accelerator 30A-30D, the address may be translated in the MMU 40 for transmission on the bus by the bus interface circuit 42. The MMU 40 may be accessed in any fashion. For example, the bus interface circuit 42 may access the MMU 40 prior to initiating a transaction on the bus. The MMU 40 may be arranged in between the input memory 38/output memory 36 (which may store virtual addresses) and may provide translations as the addresses are passed to the bus interface circuit 42. The MMU 40 may be arranged in parallel with the input memory 38/output memory 36 or in between the input memory 38/output memory 36 and the accelerators 30A-30D and may provide translations as addresses are placed in the input memory 38/output memory 36.

The MMU 40 may share the translation mechanism employed by the CPU 12. Generally, the MMU 40 includes a translation lookaside buffer (TLB) storing mappings of virtual addresses to physical addresses. The MMU 40 may include circuitry to search the translation tables in memory which store the virtual to physical translation information if a virtual address misses in the TLB, or may be configured to interrupt the CPU 12 and allow the CPU 12 to perform the search and to write the translation into the TLB. The TLB may be generic, allowing variable page sizes by selectively masking bits of the virtual and physical addresses stored in the TLB entries. Other page attributes (e.g. cacheability, etc.) may be stored or not stored in the TLB entries, as desired.

It is noted that, in various embodiments, one or more of the shared resources 32 may be eliminated. For example, if virtual addressing is not used, the MMU 40 may be eliminated. The global control circuit 34 may be eliminated and configuration registers/transaction decoding may be performed in the accelerators 30A-30D. Similarly, the input memory 38/output memory 36 may be eliminated and the accelerators 30A-30D may communicate transactions directly to the bus interface circuit 42.

Generally, the accelerators 30A-30D may be any set of accelerators. While four accelerators are illustrated in FIG. 3, any number of one or more accelerators may be included, as desired. The accelerators may each accelerate different types of application tasks. Alternatively, two or more accelerators may accelerate the same type of application task (i.e. two or more instantiations of the same accelerator may be included).

As mentioned above, while a bus is used in the present embodiment, any type of interconnect may be used in other embodiments, as desired. Furthermore, a resource is any set of circuitry which performs a given function. If the resource is shared, the sharing circuitry may gain access to the resource when the function is desired.

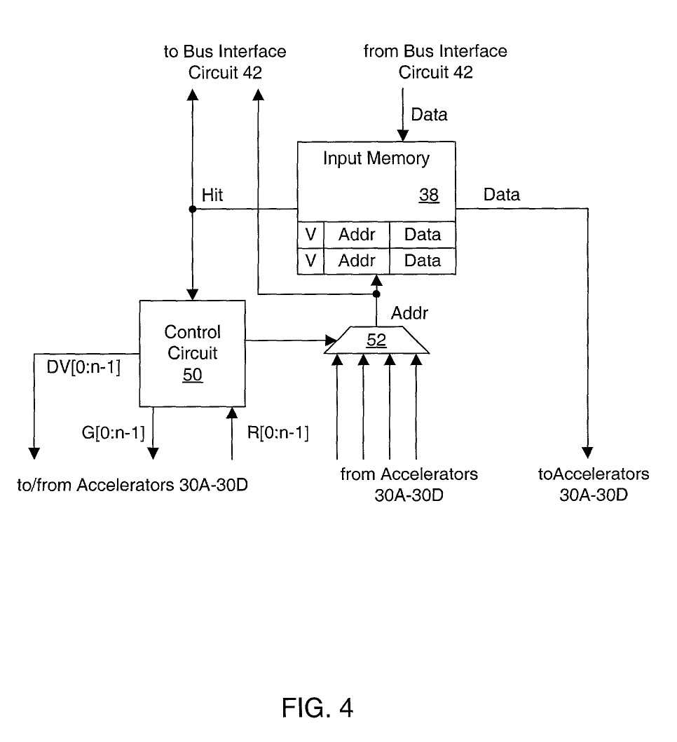

Turning next to FIGS. 4-6, block diagrams illustrating one embodiment of certain shared resources 32 and an example interface to the resources is shown. The interface of one embodiment of the accelerators 30A-30D may comprise the interfaces shown in FIGS. 4-6. Alternatively, accelerators 30A-30D may implement subsets of the interfaces, as desired. Furthermore, the interfaces shown are merely exemplary and any interface may be used.

FIG. 4 is a block diagram of one embodiment of the input memory 38 and related circuitry (which may be part of the shared resources 32). Other embodiments are possible and contemplated. Illustrated in FIG. 4 is control circuit 50 coupled to the input memory 38 and a multiplexor (mux) 52.

The control circuit 50 is configured to allow access to the input memory 38 by the accelerators 30A-30D. In the illustrated embodiment, a request/grant structure is employed for arbitrating access to the input memory 38. A set of request signals (R[0:n−1] in FIG. 4, were “n” is the number of accelerators 30A-30D) are received, one from each of the accelerators 30A-30D. A particular accelerator 30A-30D may assert its request signal if a read request is desired. The control circuit 50 grants access to one of the requesting accelerators 30A-30D using a set of grant signals (G[0:n−1] in FIG. 4), again one for each of the accelerators 30A-30D. Each of the accelerators is coupled to provide an address of a read request as in input to the mux 52, and the control circuit 50 is coupled to provide a select control to the mux 52. The selected address is provided through the mux 52 to the input memory 38, and is also routed to the bus interface circuit 42.

The input memory 38 compares the selected address to the addresses stored therein. Generally, the input memory 38 includes a plurality of entries (e.g. two entries are illustrated in FIG. 4 including a valid bit, an address, and the corresponding data). For example, the input memory 38 may comprise a content addressable memory (CAM), with the comparing portion being the address field in each entry. Alternatively, the input memory 38 may read one or more addresses from the input memory 38 for comparison to the input address.

If an address match is detected, the input memory 38 may assert a hit signal to the control circuit 50 and the bus interface circuit 42. Additionally, the input memory 38 may supply the data from the entry for which the address match is detected to the accelerators 30A-30D. The control circuit 50 may respond to the asserted hit signal by asserting a data valid signal (DV[0:n−1] in FIG. 4) to the requesting accelerator 30A-30D.

If a miss is detected (deasserted hit signal), the bus interface circuit 42 may capture the address and perform the read transaction on the bus to read the data. The data (and possibly the address as well, in some embodiments) is supplied by the bus interface circuit 42 for storage in the input memory 38. Any replacement algorithm may be used to select one of the entries in the input memory 38 for storing the data (e.g. least recently used, first-in first-out, random, etc.). The data may be forwarded to the accelerator 30A-30D (e.g. via a bypass path, or from the input memory 38 after update therein, depending on the embodiment).

As mentioned above, the interface illustrated in FIG. 4 is merely exemplary and may be varied from embodiment to embodiment. For example, instead of a request/grant interface for arbitration, any other arbitration mechanism may be used. A round robin mechanism (in which each agent is granted access every “n” clock cycles) may be used. Any other signalling mechanism may be used. FIG. 4 illustrates that, in some embodiments, the accelerators 30A-30D may share a data path into and/or out of the input memory 38. However, other embodiments may provide separate ports for each accelerator 30A-30D. The multiple ports may allow for concurrent access by two or more of the accelerators 30A-30D to the input memory 38.

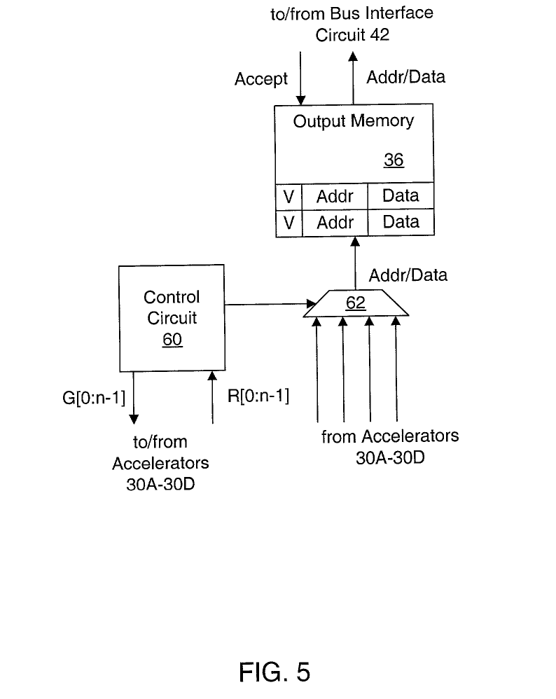

FIG. 5 is a block diagram of one embodiment of the output memory 36 and related circuitry (which may be part of the shared resources 32). Other embodiments are possible and contemplated. Illustrated in FIG. 5 is control circuit 60 coupled to the output memory 36 and a multiplexor (mux) 62.

As illustrated in FIG. 5, the control circuit 60 may employ a request/grant interface similar to the one shown in FIG. 4 to allow access to the output memory 36. Alternatively, any other interface may be used, as mentioned above. FIG. 5 illustrates that, in some embodiments, the accelerators 30A-30D may share a data path into and out of the output memory 36. However, other embodiments may provide separate ports for each accelerators 30A-30D.

The output memory 36 may comprise multiple entries, each configured to store a valid bit, an address, and corresponding data to be written to memory. Two exemplary entries are illustrated in FIG. 5. The address and data may be supplied by the request accelerator 30A-30D, and may be updated into an entry and the valid bit set. The output memory 36 may supply the address and data from a selected entry to the bus interface circuit 42 for writing to memory. The bus interface circuit 42 may indicate acceptance of the write (e.g. via an accept signal illustrated in FIG. 5), and the output memory 36 may invalidate the entry which was storing the address and data provided to the bus interface circuit 42. The output memory 36 may use any mechanism for selecting entries for transmission to the bus interface circuit 42 (e.g. first-in first-out, prioritized by requestor, etc.).

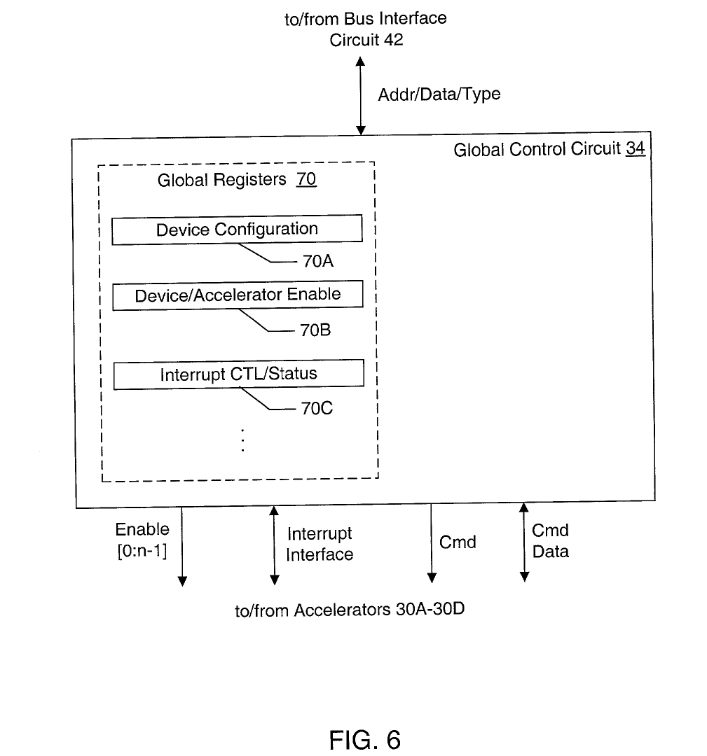

FIG. 6 is a block diagram of one embodiment of the global control circuit 34. Other embodiments are possible and contemplated. As illustrated in FIG. 6, the global control circuit 34 includes a set of global registers 70. The global control circuit 34 is coupled to an address/data/type interface to the bus interface circuit 42 and is coupled to the accelerators 30A-30D via a variety of control signals/interfaces.

The global registers 70 may be programmed, using instructions executed in the CPU 12, with various configuration/control values used to control the acceleration engine 22. In one embodiment, the global registers 70 may be memory-mapped. The bus interface circuit 42 may transmit transactions received on the bus to the global control circuit 34 for decoding, to determine if the transactions read or write the global registers 70. Alternatively, I/O transactions or configuration transactions (e.g. PCI configuration transactions) may be used to read/write the global registers 70.

Various configuration registers may be included in the global registers 70. For example, one or more device configuration registers 70A may be programmed with configuration information. The configuration information may control the operation of one or more circuits in the acceleration engine 22. For example, bus interface configuration information may be provided in the device configuration registers 70A. The global control circuit 34 may provide an interface to the bus interface circuit 42 to supply control signals based on the bus interface configuration information. Alternatively, the configuration registers 70A which store bus interface configuration information may be located in the bus interface circuit 42. Similarly, an accelerator 30A-30D may be programmably configurable. For example, a code translator may be allocated a block of memory to cache translated code sequences. The base address of the block, as well as the size of cache entries, may be programmed. Additionally, the maximum size of a translated code sequence may be configurable and be placed in a configuration register. Additionally, in one embodiment, the programming interface may be configurable to assign service ports to processes (described in more detail below). A configuration register 70A may store which service ports are allocated, so that a request for service port allocation allocates a currently unused service port.

The global registers 70 may also include one or more enable registers 70B which store device/accelerator enables. For example, an overall device enable may be included which enables operation of the accelerator engine 22. Additionally, per-accelerator enables may be included to allow enabling/disabling of individual accelerators 30A-30D. Alternatively, only the device enable or only the per-accelerator enables may be included. The global control circuit 34 may supply an enable control signal to the accelerators 30A-30D (e.g. Enable[0:n−1] in FIG. 6) based on the values in the enable registers 70B. If only a device enable is provided, the enable signal may be a shared signal supplied to all the accelerators 30A-30D. If individual accelerator enables are provided, the enable signals may be generated on a per-accelerator basis as illustrated in FIG. 6.

The global registers 70 may include one or more interrupt registers 70C to support interrupt servicing from the CPU 12. The interrupt registers 70C may provide a shared resource for posting interrupts and corresponding information. Thus, when the CPU 12 services an interrupt from the accelerator engine 22, the CPU 12 may read one set of interrupt registers and determine which accelerator 30A-30D posted the interrupt, as well as the reason for the interrupt. The global control circuit 34 may be coupled to an interrupt interface to the accelerators 30A-30D. The accelerators 30A-30D may use the interrupt interface to request an interrupt and to provide interrupt reason information, which the global control circuit 34 may store in the interrupt registers 70C. If an interrupt is requested, the global control circuit 34 may communicate an interrupt request to the bus interface circuit 42 (or may assert an interrupt signal to the CPU 12 directly).

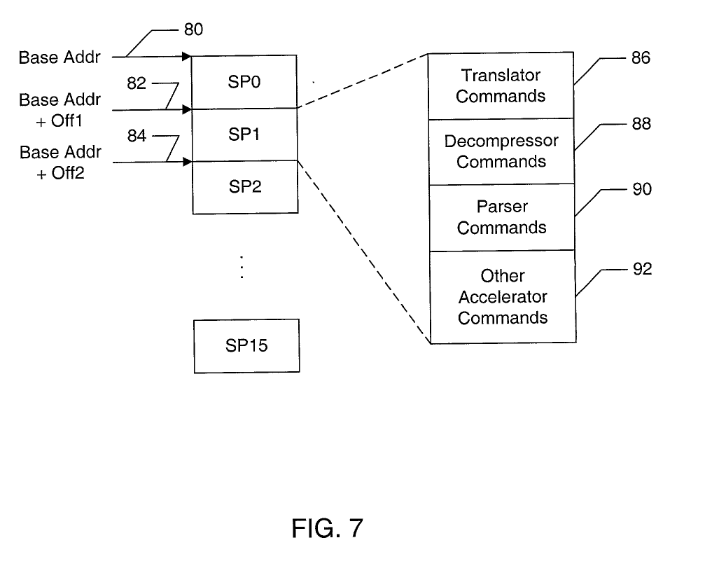

Additionally, the global control circuit 34 may interpret bus transactions which are part of the programming interface to the accelerators 30A-30D. In one embodiment, the programming interface is a set of memory-mapped addresses. Each address, along with the read/write (load/store) nature of the transaction, is interpreted as a command to one of the accelerators 30A-30D. In one particular implementation, a set of service ports are defined. Each service port may be assigned to a process (e.g. an application program, or a thread within an application program that is multithreaded). Offsets within the service port may be used as commands to one of the accelerators 30A-30D, as illustrated in FIG. 7 below. Other embodiments may define the programming interface differently, as mentioned above.

The global control circuit 34 may decode the transactions routed thereto by the bus interface circuit 42 to determine if the transactions represent commands to the accelerators 30A-30D. The global control circuit 34 may route a command (Cmd in FIG. 6) to the accelerators 30A-30D, and a command data interface (Cmd Data) may be used to transfer data associated with the command (e.g. operands/results) to and from the accelerators 30A-30D. The global control circuit 34 may supply separate commands (Cmd) to each accelerator 30A-30D (thus allowing a given command encoding to have different meanings dependent on the receiving accelerator 30A-30D) or may broadcast the same command to the accelerators 30A-30D (in which case different command encodings may be assigned to each accelerator or the command may be tagged to indicate which accelerator 30A-30D the command is being routed to).

The command interface provided by the global control circuit 34 may insulate the accelerators 30A-30D from the details of a given system implementation. The global control circuit 34 may handle decoding the transaction information to determine the command, and may route the command accordingly to the accelerator 30A-30D to which the command is directed.

Turning now to FIG. 7, a block diagram illustrating an exemplary embodiment of the programming interface to the accelerators 30A-30D is shown. Other embodiments are possible and contemplated. In the embodiment of FIG. 7, a base address (arrow 80) defines an address range which is divided into a plurality of service ports (e.g. 16 service ports labeled SP0-SP15). Each service port comprises a set of addresses within the range. Thus, the beginning of service port 1 (SP1) is at the base address plus an offset equal to the size of the service port 0 (SP0) (arrow 82). Similarly, the beginning of service port 2 (SP2) is at the base address plus an offset equal to the size of SP0 and SP1 (arrow 84). The service ports may each be of the same size, and thus the offset to SP2 may be twice the offset to SP1, etc.

A process may request a service port assignment by transmitting a command to the acceleration engine 22 (e.g. to a memory-mapped address outside of the service port address range). The global control circuit 34 may process the request by assigning a currently unused service port and responding to the command with an indication of which service port is assigned (or, if no service ports are currently available, with an indication that no service port is available). Similarly, when a process is completing (or is finished using the acceleration engine 22), the process may free the service port by transmitting another command to the acceleration engine 22. The global control circuit 34 may process the command and mark the service port as free.

Addresses within each service port are assigned as commands to one of the accelerators 30A-30D. SP2 is shown in exploded view in FIG. 7. A first range of addresses within the service port may be assigned to code translator commands (reference numeral 86). Thus, to communicate with the code translator accelerator (if included in the accelerators 30A-30D), the application program uses load/store instructions to addresses within the portion of the service port assigned to the code translator. Similarly, a second range of addresses is assigned to decompressor commands (reference numeral 88), a third range of addresses is assigned to parser commands (reference numeral 90), and other ranges of addresses may be assigned to other accelerators (reference numeral 92). The arrangement of address ranges assigned to various accelerators may be varied from embodiment to embodiment.

Accelerator Framework Methodology

The modular structure of the accelerator engine 22 may provide for a methodology for creating implementations of the accelerator engine 22. Particularly, a library of circuits may be developed, and circuits may be selected for a given implementation. The selected circuits may be assembled into an implementation of the accelerator engine 22 targeted at a particular system implementation and having the accelerators desired in that system.

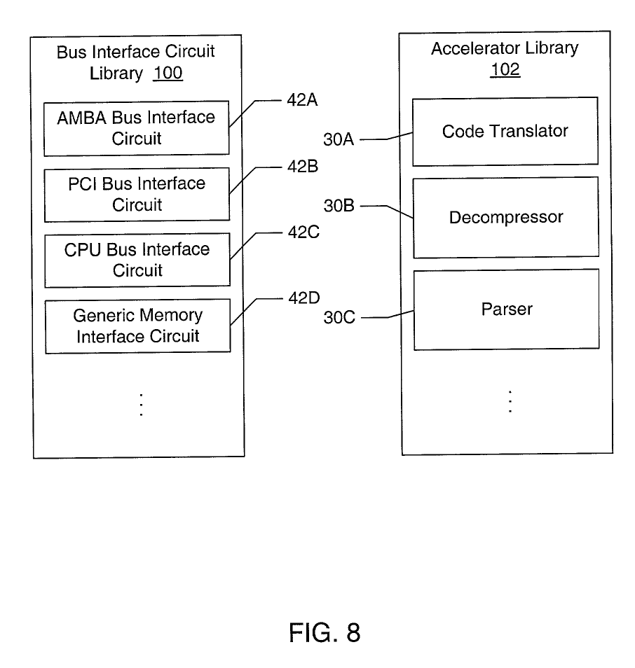

For example, FIG. 8 illustrates a bus interface circuit library 100 and an accelerator library 102. Generally, a circuit library may be a data structure of circuit representations (e.g. RTL, netlist, schematic, etc.) which may be combined to produce an overall circuit representation (e.g. a representation of an application engine 22 or a system 10 or portion thereof), which may then be used to fabricate an integrated circuit comprising the overall circuit representation (possibly through intermediate steps such as synthesis, place and route, mask generation, etc.).

The bus interface circuit library 100 includes a plurality of circuit representations of bus interface circuits. Any number and type of bus interface circuits may be included in the bus interface circuit library 100. In the example illustrated in FIG. 8, the bus interface circuit library 100 may include data structure representations of an AMBA bus interface circuit 42A, a PCI bus interface circuit 42B, a CPU bus interface circuit 42C corresponding to the interface to CPU 12, a generic memory interface circuit 42D for interfacing to a memory such as the memory 16, etc. Each of the bus interface circuits in the bus interface circuit library 100 may include a common interface to the other shared resources and/or the accelerators 30A-30D.

The accelerator library 102 includes a plurality of accelerator representations. For example, in the illustrated embodiment, the accelerator library 102 includes data structure representations of a code translator 30A, a decompressor 30B, a parser 30C, etc. Each of the accelerators may include a common interface to the shared resources.

It is noted that other libraries may be included as well. For example, a library of global control circuits 34 may be included if the global control circuit 34 changes based on the targeted system configuration and/or the accelerators selected for inclusion. Similarly, libraries of any of the other shared resources may be included, as desired.

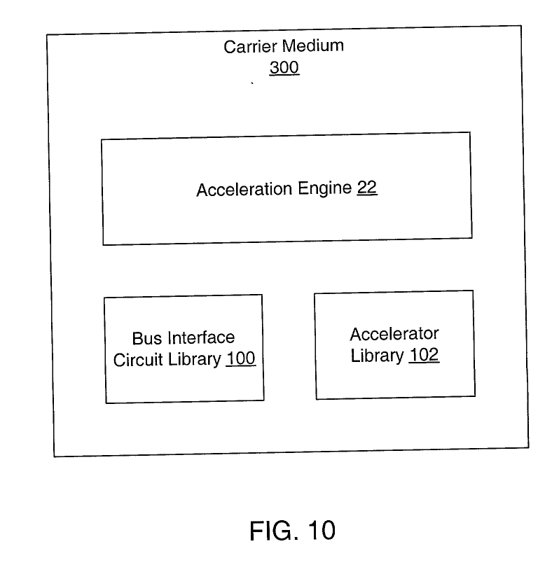

Generally, the libraries 100-102 may be stored/carried on any type of carrier medium (e.g. carrier medium 300 shown in FIG. 10 below).

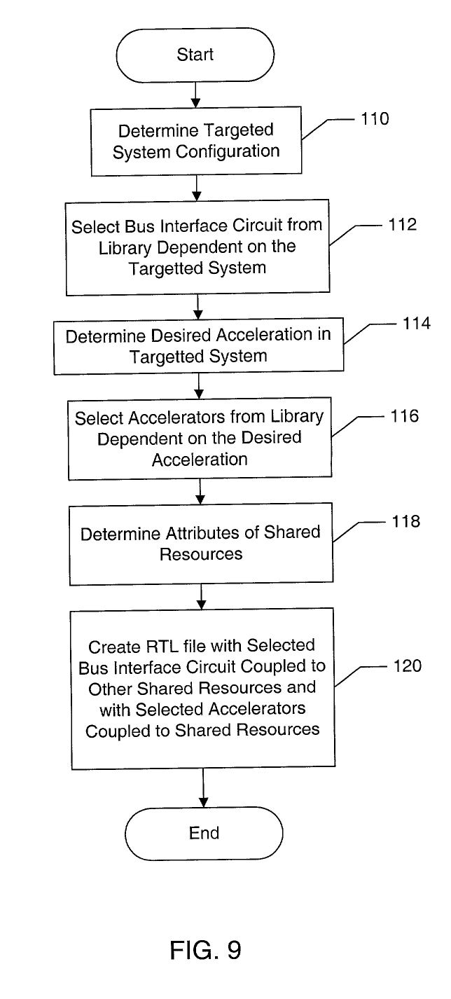

Turning now to FIG. 9, a flowchart is shown illustrating at least a portion of an exemplary methodology for creating an implementation of the acceleration engine 22 (or a system including the acceleration engine 22). Other embodiments are possible and contemplated.

The targeted system configuration is determined (block 110). For example, the interface that will be used for the acceleration engine 22 may be selected. The interface may be an expansion bus interface (e.g. PCI), or may be an interface used by the selected CPU 12, as desired. Depending on the targeted system configuration, the bus interface circuit to be included in the acceleration engine 22 is selected from the bus interface circuit library 100 (block 112).

The acceleration desired in the system is determined (block 114). The type of acceleration may depend on the intended applications to be executed on the system, as well as the product the system is to be included in (or forms). The accelerators to be included in the acceleration engine 22 are then selected from the accelerator library 102 dependent on the desired acceleration for the system (block 116).

Various attributes of the shared resources 32 (and/or the accelerators 30A-30D) may be configurable on an implementation by implementation basis. For example, the number of entries in the input memory 38 and the number of entries in the output memory 36 may be programmable. Furthermore, the number of entries in the TLB of the MMU 40 (if included) may be programmable. Such attributes are selected (block 118). The number of entries in the input memory 38 and/or the output memory 36 may be affected by the number of accelerators to be included as well as the latency characteristics of the selected bus, for example.

An RTL file is created which includes the selected bus interface circuit coupled to the other shared resources and with the selected (one or more) accelerators coupled to the shared resources. Additionally, the attributes of the shared resources are set according to the determination in block 118 (block 120). Subsequently, the RTL file may be synthesized to produce a netlist which may be combined with zero or more other netlists to produce the netlists for an integrated circuit, which may then be placed and routed and mask data may be generated therefrom for fabricating the integrated circuit.

Turning now to FIG. 10, a block diagram of a carrier medium 300 including a data structure representative of the acceleration engine 22 is shown. The carrier medium may further (or alternatively) carry the bus interface circuit library 100 and/or the accelerator library 102, as mentioned above. Generally speaking, a carrier medium may include storage media such as magnetic or optical media, e.g., disk or CD-ROM, volatile or non-volatile memory media such as RAM (e.g. SDRAM, RDRAM, SRAM, etc.), ROM, etc., as well as transmission media or signals such as electrical, electromagnetic, or digital signals, conveyed via a communication medium such as a network and/or a wireless link.

Generally, the data structure of the acceleration engine 22 carried on the carrier medium 300 may be a data structure which can be read by a program and used, directly or indirectly, to fabricate the hardware comprising the acceleration engine 22. For example, the data structure may be a behavioral-level description or register-transfer level (RTL) description of the hardware functionality in a high level design language (HDL) such as Verilog or VHDL. The description may be read by a synthesis tool which may synthesize the description to produce a netlist comprising a list of gates in a synthesis library. The netlist comprises a set of gates and interconnect therebetween which also represent the functionality of the hardware comprising the acceleration engine 22. The netlist may then be placed and routed to produce a data set describing geometric shapes to be applied to masks. The data set, for example, may be a GDSII (General Design System, second revision) data set. The masks may then be used in various semiconductor fabrication steps to produce a semiconductor circuit or circuits corresponding to the acceleration engine 22. Alternatively, the data structure on the carrier medium 300 may be the netlist (with or without the synthesis library) or the data set, as desired.

While the carrier medium 300 carries a representation of the acceleration engine 22, other embodiments may carry a representation of any portion of the acceleration engine 22, as desired, including any combination of accelerators, shared resources, input memories, output memories, bus interface circuits, global control circuits, MMUs, etc. Furthermore, the carrier medium 300 may carry a representation of any embodiment of the system 10 or any portion thereof.

Numerous variations and modifications will become apparent to those skilled in the art once the above disclosure is fully appreciated. It is intended that the following claims be interpreted to embrace all such variations and modifications.

What is claimed is:

1. An apparatus comprising:
two or more accelerators, each of the accelerators comprising circuitry configured to perform a task for an application program; and
one or more resources coupled to the accelerators, the resources shared by the accelerators and configured to interface the accelerators to an interconnect and further configured to provide a programming interface for communication with the accelerators.

2. The apparatus as recited in claim 1 wherein the programming interface is used by the application program to communicate with the accelerators.

3. The apparatus as recited in claim 1 wherein the resources include an interface circuit configured to communicate on the interconnect.

4. The apparatus as recited in claim 3 wherein the resources include a control circuit configured to provide the programming interface.

5. The apparatus as recited in claim 4 wherein the programming interface comprises one or more memory-mapped commands, and wherein the control circuit is configured to decode the addresses of transactions on the interconnect to detect the commands and is further configured to transmit indications of the commands to a corresponding one of the accelerators.

6. The apparatus as recited in claim 4 wherein the control circuit includes one or more registers, and wherein the control circuit is configured to supply control signals to the accelerators responsive to values in the registers.

7. The apparatus as recited in claim 4 wherein the control circuit includes one or more interrupt registers, and wherein the control circuit is coupled to receive interrupt information from any of the accelerators for storage in the interrupt registers for reading by a central processing unit (CPU) in response to an interrupt from the apparatus.

8. The apparatus as recited in claim 3 wherein the resources further comprise a first memory coupled to the interface circuit, the first memory including one or more entries for storing data accessed by the accelerators.

9. The apparatus as recited in claim 8 wherein the first memory is an input memory for storing data read by the accelerators, the input memory coupled to receive data from the interface circuit and to provide data to the accelerators.

10. The apparatus as recited in claim 8 wherein the first memory is an output memory for storing data written by the accelerators, the output memory coupled to receive data from the accelerators and to provide data to the interface circuit.

11. The apparatus as recited in claim 8 further comprising circuitry configured to provide access to the first memory by each of the accelerators.

12. The apparatus as recited in claim 3 wherein the resources further include a memory management unit (MMU) configured to translate virtual addresses provided by the application program to physical addresses for accessing a memory.

13. The apparatus as recited in claim 1 wherein the accelerators include one or more code translators.

14. The apparatus as recited in claim 1 wherein the accelerators include one or more decompressors.

15. The apparatus as recited in claim 1 wherein the accelerators include one or more parsers.

16. A carrier medium configured to hold a data structure representative of:
two or more accelerators, each of the accelerators comprising circuitry configured to perform a task for an application program; and
one or more resources coupled to the accelerators, the resources shared by the accelerators and configured to interface the accelerators to an interconnect and further configured to provide a programming interface for communication with the accelerators.

17. The carrier medium as recited in claim 16 wherein the programming interface is used by the application program to communicate with the accelerators.

18. The carrier medium as recited in claim 16 wherein the resources include an interface circuit configured to communicate on the interconnect.

19. The carrier medium as recited in claim 18 wherein the resources include a control circuit configured to provide the programming interface.

20. The carrier medium as recited in claim 19 wherein the programming interface comprises one or more memory-mapped commands, and wherein the control circuit is configured to decode the addresses of transactions on the interconnect to detect the commands and is further configured to transmit indications of the commands to a corresponding one of the accelerators.

21. The carrier medium as recited in claim 19 wherein the control circuit includes one or more registers, and wherein the control circuit is configured to supply control signals to the accelerators responsive to values in the registers.

22. The carrier medium as recited in claim 19 wherein the control circuit includes one or more interrupt registers, and wherein the control circuit is coupled to receive interrupt information from any of the accelerators for storage in the interrupt registers for reading by a central processing unit (CPU) in response to an interrupt.

23. The carrier medium as recited in claim 18 wherein the resources further comprise a first memory coupled to the interface circuit, the first memory including one or more entries for storing data accessed by the accelerators.

24. The carrier medium as recited in claim 23 wherein the first memory is an input memory for storing data read by the accelerators, the input memory coupled to receive data from the interface circuit and to provide data to the accelerators.

25. The carrier medium as recited in claim 23 wherein the first memory is an output memory for storing data written by the accelerators, the output memory coupled to receive data from the accelerators and to provide data to the interface circuit.

26. The carrier medium as recited in claim 23 further comprising circuitry configured to provide access to the first memory by each of the accelerators.

27. The carrier medium as recited in claim 18 wherein the resources further include a memory management unit (MMU) configured to translate virtual addresses provided by the application program to physical addresses for accessing a memory.

28. The carrier medium as recited in claim 16 wherein the accelerators include one or more code translators.

29. The carrier medium as recited in claim 16 wherein the accelerators include one or more decompressors.

30. The carrier medium as recited in claim 16 wherein the accelerators include one or more parsers.

31. A method comprising:
selecting an interface circuit from a library of interface circuits dependent on a system into which an accelerator engine comprising the interface circuit is to be included;
selecting one or more accelerators from a library of accelerators dependent on which application tasks are to be accelerated; and
forming a data structure representing the accelerator engine by coupling a representation of the bus interface circuit, a representation of one or more shared resources, and a representation of the accelerators.

32. The method as recited in claim 31 wherein the data structure comprises a register transfer level description.

33. The method as recited in claim 31 wherein the one or more resources are described by one or more attributes, the method further comprising selecting values for the one or more attributes.

34. The method as recited in claim 33 wherein the resources including a first memory comprising one or more entries configured to store data accessed by the accelerators, wherein the attributes include a number of the one or more entries.

35. The method as recited in claim 31 wherein the one or more shared resources include one or more optional resources selectively included in the data structure.
